(19) United States
(12) Patent Application Publication
(10) Pub. No.: US 2021/0232405 A1
(43) Pub. Date: Jul. 29, 2021

(54) CIRCUIT AND REGISTER TO PREVENT EXECUTABLE CODE ACCESS

(71) Applicant: QUALCOMM Incorporated, San Diego, CA (US)

(72) Inventors: Sujith KOTTILA VEETTIL, Hyderabad (IN); Srinivas PULICHERLA, Hyderabad (IN); Sukumar Babu MADDELA, Hyderabad (IN)

(21) Appl. No.: 16/773,680

(22) Filed: Jan. 27, 2020

(51) Int. Cl. G06F 9/4401; G06F 9/30; G06F 12/14; G06F 15/78

(52) U.S. Cl. CPC G06F 9/4401; G06F 9/30101; G06F 15/7807; G06F 12/1441; G06F 9/30083

(57) ABSTRACT

Certain aspects provide a computing system including a first CPU configured to load executable code for the computing system. The computing system further includes a first memory configured to store the executable code at an address range of the first memory. The first memory is local to a second CPU. The computing system further includes a one-time programmable or read-only register configured to store an indication of the address range. The computing system further includes a circuit configured to: determine if a first memory address associated with a first memory access command is in the address range based on the indication of the address range stored in the register; when the first memory address is in the address range, refrain from sending the first command to the first memory; and when the first memory address is not in the address range, send the first command to the first memory.

### TECHNICAL FIELD

The teachings of the present disclosure relate generally to system-on-chip (SoC) integrated circuit design, and in certain aspects, to systems, apparatuses, and methods for preventing access to certain executable code on a SoC.

### INTRODUCTION

Computing devices are ubiquitous. Some computing devices are portable such as mobile phones, tablets, and laptop computers. As the functionality of such portable computing devices increases, the computing or processing power required and generally the data storage capacity to support such functionality also increases. In addition to the primary function of these devices, many include elements that support peripheral functions. For example, a cellular telephone may include the primary function of enabling and supporting cellular telephone calls and the peripheral functions of a still camera, a video camera, global positioning system (GPS) navigation, web browsing, sending and receiving emails, sending and receiving text messages, push-to-talk capabilities, etc. Many of these portable devices include a SoC to enable one or more primary and peripheral functions on the specific device.

A SoC generally includes multiple central processing unit (CPU) cores embedded in an integrated circuit or chip and coupled to a local bus. The CPU cores may further be arranged into one or more computing clusters. The SoC may further generally include hardware components and other processors.

The SoC, like larger computing devices such as desktop and server computers relies on a boot sequence or a boot code upon powering up. The boot sequence is the initial set of operations that the SoC performs when power is first applied to the SoC. The boot code enables a (e.g., bootstrapping) process that initializes the SoC. The boot code is typically stored in a read-only memory (ROM) for quick access, low complexity, spatial efficiency, low cost, and security reasons.

The boot sequence may utilize internal memory (e.g., on-chip memory that is on the same chip as the SoC, such as static random-access memory (SRAM)) and complex drivers to securely boot the SoC, as well as external memory (e.g., off-chip memory that is off the same chip as the SoC, including dynamic random access memory (DRAM), such as double data rate (DDR) synchronous DRAM (SDRAM), low power DDR (LPDDR), etc.) such as to save costs on the amount of internal memory used when the SoC has more functionality that requires more memory to boot. The external memory may be stacked with the SoC (e.g., application processor, modem chip, etc.), may be configured as a package on package design, may be completely external (e.g., not on the same package as the SoC), etc.

As part of the boot sequence, a CPU designated to boot the SoC may load, such as from an external memory, executable code into a memory local to a second CPU. For example, the executable code may be a power management code, and the second CPU may be configured to perform power management for the SoC. The boot CPU may further authenticate the code loaded in the memory local to the second CPU, to ensure the code is not corrupt. However, after loading the executable code, components, such as CPUs of the SoC other than the second CPU can still access the code loaded in the memory local to the second CPU, and potentially corrupt the code, thereby causing errant operation of the SoC. For example, other CPUs often have access to the executable code in the memory through a circuit, such as a bus infrastructure, even if those CPUs are not a part of the same CPU subsystem (CPUSS) as the second CPU where the executable code is loaded. If those CPUs are corrupted with malicious software, the malicious software may have access to the running executable code and can potentially negatively affect the SoC. Thus, a SoC that prevents malicious software from accessing its running executable code is desired.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In some aspects, the present disclosure provides a computing system. The computing system includes a first CPU configured to load an executable code for the computing system. The computing system further includes a first memory configured to store the executable code at an address range of the first memory, wherein the first memory is local to a second CPU. The computing system also includes a one-time programmable or read-only register configured to store an indication of the address range. The computing system further includes a circuit configured to determine if a first memory address associated with a first memory access command is in the address range based on the indication of the address range stored in the register. The circuit is further configured to, when the first memory address is in the address range, refrain from sending the first command to the first memory address. The circuit is also configured to, when the first memory address is not in the address range, send the first command to the first memory address.

In some aspects, the present disclosure provides a computing system. The computing system includes a first CPU. The computing system further includes a second CPU. The computing system also includes a first memory configured to store an executable code at an address range of the first memory, wherein the first memory is local to a second CPU. The computing system further includes a bus fabric coupled between the first CPU and the first memory, and between the first CPU and the second CPU. The computing system also includes a one-time programmable or read-only register configured to store an indication of whether to remove the address range from a memory map of the computing system. The bus fabric is configured to remove the address range from the memory map when the indication indicates to remove the address range from the memory map. The bus fabric is further configured to receive a first memory access command indicating a first memory address after removing the address range from the memory map. The bus fabric is also configured to, when the first memory address is not in the memory map, refrain from sending the first command to the first memory address. The bus fabric is further configured to, when the first memory address is in the memory map, send the first command to the first memory address.

In some aspects, the present disclosure provides a method of preventing access to executable code. The method includes loading, by a first CPU, executable code into a first memory local to a second CPU at an address range of the first memory. The method further includes, after loading the executable code, setting a one-time programmable or read-only register to indicate to remove the address range from a memory map accessible by a bus fabric. The method also includes removing, by the bus fabric, the address range from the memory map based on the setting of the register. The method further includes preventing, by the bus fabric, access to the address range via the bus fabric based on the memory map not including the address range.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an exemplary system-on-chip (SoC), in accordance with certain aspects of the present disclosure.

FIG. 2 illustrates a flow diagram for booting a SoC, in accordance with certain aspects of the present disclosure.

FIG. 3 illustrates a flow diagram for preventing access to executable code, in accordance with certain aspects of the present disclosure.

FIG. 4 illustrates exemplary operations for preventing access to executable code, in accordance with certain aspects of the present disclosure.

FIG. 5 illustrates a flowchart of a method for preventing access to executable code, in accordance with certain aspects of the present disclosure.

FIG. 6 illustrates exemplary operations of a method of preventing access to executable code according to certain aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Although the teachings of this disclosure are illustrated in terms of integrated circuits (e.g., a SoC), the teachings are applicable in other areas. The teachings disclosed should not be construed to be limited to SoC designs or the illustrated embodiments. The illustrated embodiments are merely vehicles to describe and illustrate examples of the inventive teachings disclosed herein. Further, though certain firmware image loading techniques are described with respect to certain hardware components or processors, similar techniques may be used for loading firmware images of other components that are booted (e.g., by a SoC).

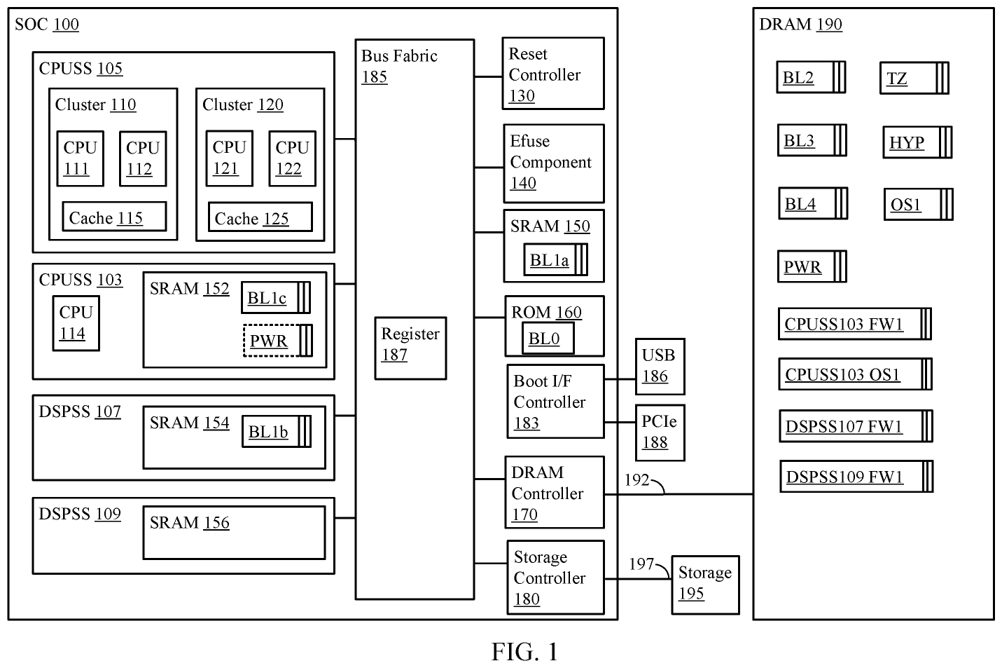

FIG. 1 is an illustration of an exemplary SoC 100, in accordance with certain aspects of the present disclosure. The SoC 100 may be interconnected to other chips by one or more chip-to-chip interfaces such as peripheral component interconnect express (PCIe), universal serial bus (USB), serial peripheral interface (SPI), etc. In certain aspects, one of the one or more chip-to-chip interfaces may be used for boot.

As shown, the SoC 100 includes a CPU sub-system (CPUSS) 105. The CPUSS 105 includes a plurality of CPU cores 111, 112, 121, and 122. Though CPUSS 105 is shown with a particular number of CPU cores, it should be noted that there may be additional or fewer cores in CPUSS 105. Further, CPU cores 111 and 112 are part of a cluster 110, and CPU cores 121 and 122 are part of a cluster 120. Again, though shown with a particular number of CPU clusters, CPUSS 105 may include additional or fewer clusters. Further, each cluster may include the same or a different number of CPU cores. The CPU cores 111, 112, 121, and 122 may be of the same type, or may be of different types (e.g., ARM design, non-ARM design, etc.). Further, the CPU cores of a given cluster (e.g., CPU cluster 110 or 120) may be of the same type, or may be of different types (e.g., in-cluster big.LITTLE design, cluster based big.LITTLE design, etc.).

Further, the CPUSS 105 may include CPU resources, such as one or more caches. As shown, each cluster 110 and 120 includes a cache 115 and 125, respectively. In certain aspects, the CPU cores of the clusters 110 and 120 may share the cache 115 and 125, respectively, for memory storage. It should be noted that the CPUSS 105 may include additional or different CPU resources than those shown. For example, in some aspects, one or more CPU cores may have its own associated cache, one or more clusters may have its own associated cache (e.g., shared by CPU cores of the cluster), and/or the CPUSS 105 may include one or more caches shared by one or more clusters and/or CPU cores. The SoC 100 further may include additional CPUSS 103, and one or more additional digital signal processor sub-systems (DSPSS). In certain aspects, each of CPUSS 103, DSPSS 107, and DSPSS 109 may have its own SRAM 152, 154, and 156, respectively, for reading and writing data.

The SoC 100 further includes a reset controller 130, an efuse component 140, static random-access memory (SRAM) 150, a read only memory (ROM) 160, a dynamic RAM (DRAM) controller 170, a storage (e.g., flash) controller 180, and a boot interface (I/F) controller 183, which are all shown as internal (e.g., on-chip) components of the SoC 100. The internal components of the SoC 100 are coupled together by a bus fabric 185. Further, the DRAM controller 170 is coupled to a DRAM 190 external (e.g., off-chip) from the SoC 100 by a bus 192. The DRAM 190 may be stacked with the SoC 100, may be configured as a package on package design, may be completely external (e.g., not on the same package as the SoC 100), etc. The storage (e.g., flash) controller 180 is coupled to a storage 195 (e.g., flash storage) external (e.g., off-chip) from the SoC 100 by a bus 197. The SRAM 150, DRAM 190, and storage 195 may provide storage capacity for the SoC 100.

In some aspects, the reset controller 130, during system boot, is configured to release a CPU core for the CPUSS 105 from reset. In some aspects, the CPU core released is then configured to execute code/data (e.g., boot code), such as ROM bootloader BL0 as shown, from the ROM 160 to boot the SoC 100 (e.g., to run a high level operating system (OS)). The ROM 160 (e.g., boot ROM) is an integrated circuit that includes the code or codes (e.g., boot code) that are executed by the CPUSS 105 during an initial power-on or upon a watchdog reset condition. In some aspects, the ROM is enabled in firmware. In some aspects, the CPUSS 105 boots (e.g., securely) from storage 195, by running firmware images stored in storage 195 for booting the SoC 100, including the various hardware components of the SoC 100. Further, though certain aspects are described with respect to the SoC 100 booting from storage 195, the SoC 100 may similarly boot (e.g., securely) from a transport layer instead of a storage (e.g., a flashless transport layer). For example, the CPUSS 105 may boot from the transport layer, by running firmware images received over the transport layer for booting the SoC 100.

In particular, SoC 100 may utilize boot I/F controller 183 to communicate with another component (e.g., another SoC) over a chip-to-chip interface. For example, boot I/F controller 183 of SoC 100 may control a chip-to-chip interface (e.g., transport layer) of SoC 100 such as PCIe 188 or USB 186 to communicate with a chip-to-chip interface of another component. Accordingly, SoC 100 may communicate over a transport layer via boot I/F controller 183.

In certain aspects, the CPUSS 105 is configured to boot by running firmware images shown as loaded in DRAM 190, SRAM 150, SRAM 152, SRAM 154, and SRAM 156. For example, the CPUSS 105 executes ROM bootloader BL0 from ROM 160. The ROM bootloader BL0 causes the CPUSS 105 to execute bootloader BL1a in SRAM 150, which initializes DRAM controller 170 and DRAM 190, and/or Boot I/F controller 183. In certain aspects, ROM bootloader BL0 initializes Boot I/F controller 183 instead of bootloader BL1a, such as in a flashless boot configuration. Accordingly, the SoC 100 can access firmware images from DRAM 190 and/or over a chip-to-chip interface. BL1a may further boot the SoC 100 by controlling execution of additional firmware images, such as bootloaders BL2, BL3, and BL4, TZ (e.g., secure world firmware), HYP (e.g., hypervisor firmware), and OS1 (e.g., operating system) on the application processor (e.g., CPUSS 105) subsystem. Further, in certain aspects, other subsystem firmware images booted during the boot process include PWR (e.g., power firmware), CPUSS103 FW1 (e.g., CPUSS 103 firmware), CPUSS103 OS1 (e.g., CPUSS 103 operating system), DSPSS107 FW1 (e.g., DSPSS 107 firmware), and DSPSS109 FW1 (e.g., DSPSS 109 firmware). In certain aspects, certain early firmware images are booted by BL1a, and the remaining firmware images are booted by an operating system such as OS1.

As shown, PWR is booted by CPUSS 103, such as by CPU 114 of CPUSS 103. In particular, as part of the boot process, CPUSS 105 (e.g., one of CPUs 111-122 indicated as a boot CPU) loads PWR from DRAM 190 into SRAM 152 that is local to CPUSS 103 and CPU 114. Further, once loaded, CPUSS 105 (e.g., one of CPUs 111-122 indicated as a boot CPU) authenticates PWR. For example, by authenticating PWR, CPUSS 105 ensures proper functioning of SoC 100.

However, as discussed, other entities, such as CPUs of CPUSS 105, DSPSS 107, DSPSS 109, etc., can conventionally access PWR stored in SRAM 152 via bus fabric 185, and potentially corrupt PWR. For example, malicious code executing on one such CPU, may corrupt PWR during execution after loading and authentication. Such execution of a corrupt PWR code could cause serious issues for the SoC 100, such as crashing of the SoC, loss in battery life, or other negative effects.

Accordingly, certain aspects herein provide techniques for preventing access to executable code (e.g., PWR) by components via a circuit (e.g., bus fabric 185) coupling components to a memory storing the executable code. In the current example, techniques herein would prevent components outside of CPUSS 103 from accessing PWR in SRAM 152, as the other components are coupled to CPUSS 103 via bus fabric 185. Though certain aspects are described herein with respect to PWR, CPUSS 103, SRAM 152, and bus fabric 185, it should be noted that such aspects can be used to prevent access to any data (e.g., executable code) stored in any memory local to any component (e.g., CPU, CPUSS, DSPSS, etc.) by components coupled to the memory via a circuit configured to implement the techniques discussed herein. For example, in certain aspects, a firewall is used as a circuit instead of bus fabric 185 to implement the techniques herein. For example, the SoC 100 may include multiple firewalls, each firewall coupled between a corresponding subsystem and other components.

In certain aspects, bus fabric 185 is configured to manage and access a memory map of SoC 100. In certain aspects, the memory map is configured to map addresses (e.g., 0x0000-FxFFFF) to different memories of the SoC 100. For example, the memory map may indicate that a first address range may map to a first portion of SRAM 152, a second address range may map to a second portion of SRAM 152, a third address range may map to a first portion of SRAM 154, etc. In particular, the memory map is used to correlate addresses to portions of memory of the SoC 100. Accordingly, when the bus fabric 185 receives a memory command indicating a memory address, the bus fabric 185 is configured to utilize the memory map to direct the memory command to the appropriate memory.

Certain aspects herein prevent access to data, such as executable code in memory of the SoC 100 by selectively removing the address range where the data is stored from the memory map. Accordingly, when the bus fabric 185 receives a memory command (e.g., a read and/or write command) for an address that is not in the memory map, the bus fabric 185 cannot map the memory command to a memory, and thus refrains from sending the memory command to a memory.

In particular, certain aspects herein provide a register 187, which is a one-time programmable or read-only register. The register 187 is configured to store an indication of an address range. In certain aspects, the indication is not the address range itself, but rather an indication (e.g., a single bit) of whether to remove the address range from the memory map. For example, when single bit is set, it indicates to remove the address range from the memory map. When the single bit is not set, it indicates to not remove the address range from the memory map. The address range itself may be defined in hardware (not shown) accessible by or embedded in the bus fabric 185.

Accordingly, when the indication in register 187 indicates to remove the address range from the memory map, the bus fabric 185 accesses the address range from the hardware, and removes the address range from the memory map. When the indication in register 187 indicates not to remove the address range from the memory map, the bus fabric 185 does not remove the address range from the memory map.

In the example of PWR discussed herein, upon hard-reset of the SoC 100, register 187 is reset, such that the indication indicates not to remove the address range from the memory map. Further, during boot after hard-reset, a CPU of CPUSS 105 is configured to load PWR into SRAM 152 in the address range defined in the hardware. In particular, since the indication indicates not to remove the address range from the memory map, the CPU of CPUSS 105 is able to issue commands via bus fabric 185 to load the PWR into SRAM 152 in the address range, which is currently part of the memory map.

After the CPU of CPUSS 105 authenticates PWR as loaded into SRAM 152, the indication in register 187 is set to indicate to remove the address range from the memory map. In certain aspects, bus fabric 185 itself is configured to set the indication based on the first access to the address range via bus fabric 185. In certain aspects, the CPU of CPUSS 105 is configured to set the indication after authenticating PWR as loaded into SRAM 152. Further, in certain aspects, since the register 187 is a one-time programmable or read-only register, once set to indicate to remove the address range from the memory map, it cannot be set to indicate to not remove the address range from the memory map until another hard-reset of the SoC 100, upon which PWR would be re-authenticated anyway.

Accordingly, as discussed, after the register 187 is set to indicate to remove the address range from the memory map, components outside of CPUSS 103, such as CPUSS 105, are unable to access PWR, as the bus fabric 185 will drop memory commands with an address in the address range. Components in the CPUSS 103, however, such as CPU 114 which needs to access and execute PWR, can still do so even after the register 187 is set to indicate to remove the address range from the memory map because CPU 114 can access SRAM 152 independently of bus fabric 185, since it is coupled to SRAM 152 without going through bus fabric 185.

Thus, the techniques herein advantageously prevent access to data and/or executable code from potential malicious components, while still allowing access to components that need to access the data and/or executable code to function.

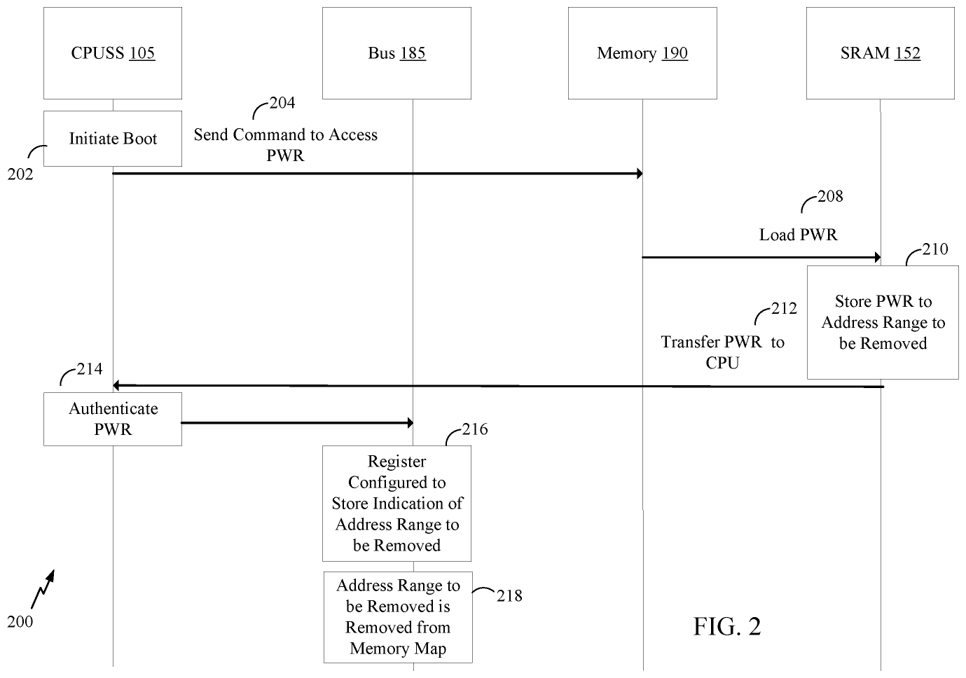

FIG. 2 illustrates a flow diagram for booting a SoC, in accordance with certain aspects of the present disclosure. Here, CPUSS 105 initiates the boot sequence at 202. After initiating the boot sequence, a CPU of CPUSS 105 sends a command(s) to load code into SRAM 152 at 204. In some aspects, the command indicates to load PWR into SRAM 152 from memory 190. The command is passed to memory 190 and executed, and thus causes PWR in memory 190 to be loaded in SRAM 152 at 208. Accordingly, PWR is stored at the address range to be removed from the memory map in SRAM 152 in CPUSS 103 at 210. In some aspects, the CPUSS where the code is loaded may be any CPUSS designated to store the code. In certain aspects, the address range to be removed from the memory map may correspond to any memory in which the executable code is loaded. At 212, PWR is transferred to CPUSS 105. At 214, PWR is authenticated by CPUSS 105. After CPUSS 105 authenticates PWR, the bus fabric 185 configures the register 187 to store an indication of the address range in SRAM 152 to be removed from the memory map at 216. In certain aspects, the bus fabric 185 configures the register 187 by setting a single bit to indicate to remove the address range from the memory map. In some aspects, the single bit is reset to not indicate to remove the address range from the memory map upon hard-reset of the SoC 100. At 218, the bus fabric 185 removes the address range from the memory map and will refrain from sending commands with an address in the removed address range. In some aspects, the address range to be removed is defined in hardware accessible to the bus fabric 185. After 216, only components that may access PWR independently of bus fabric 185 will have access to PWR.

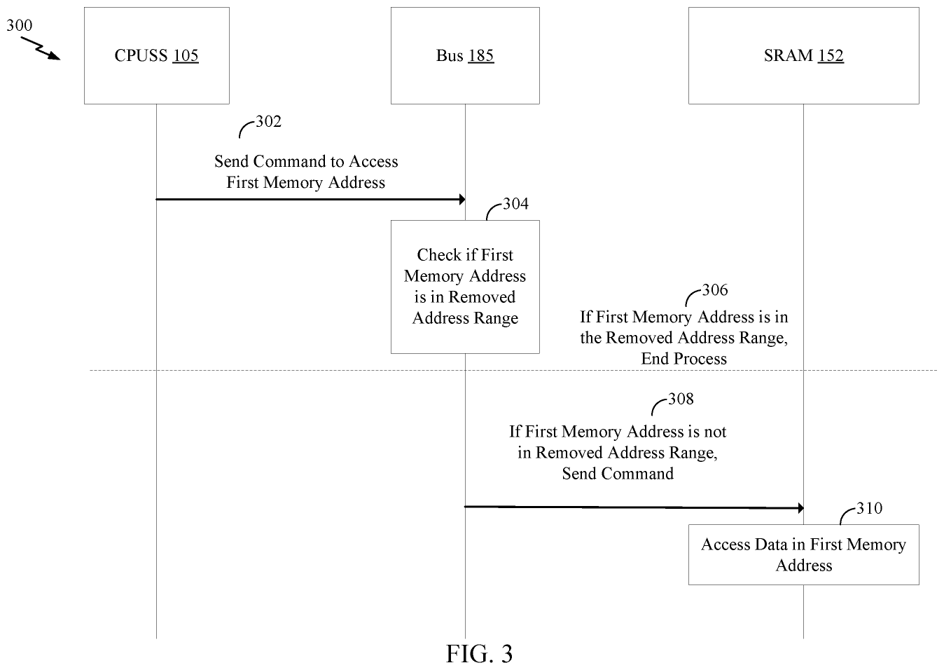

FIG. 3 illustrates a flow diagram for preventing access to executable code, in accordance with certain aspects of the present disclosure. Here, a CPU of CPUSS 105 sends a command to access a first memory address to the bus fabric 185 at 302. At 304, the bus fabric 185 checks if the first memory address is in the address range removed from the memory map. At 306, the bus fabric 185 refrains from sending the command to access the first memory address if the first memory address is in the address range removed from the memory map. In certain aspects, the bus fabric 185 refrains from sending the command to access the first memory address by ending the process. At 308, the bus fabric 185 sends the command to access the first memory address if the first memory is not in the address range removed from the memory map. At 310, if the bus fabric 185 sent the command to access the first memory address, the first memory address is accessed. In some aspects, if the first memory address is accessed and the command is a write command, data indicated in the command is written to the first memory at the first memory address. In certain aspects, if the first memory address is accessed and the command is a read command, then data stored at the first memory address is transferred to CPUSS 105.

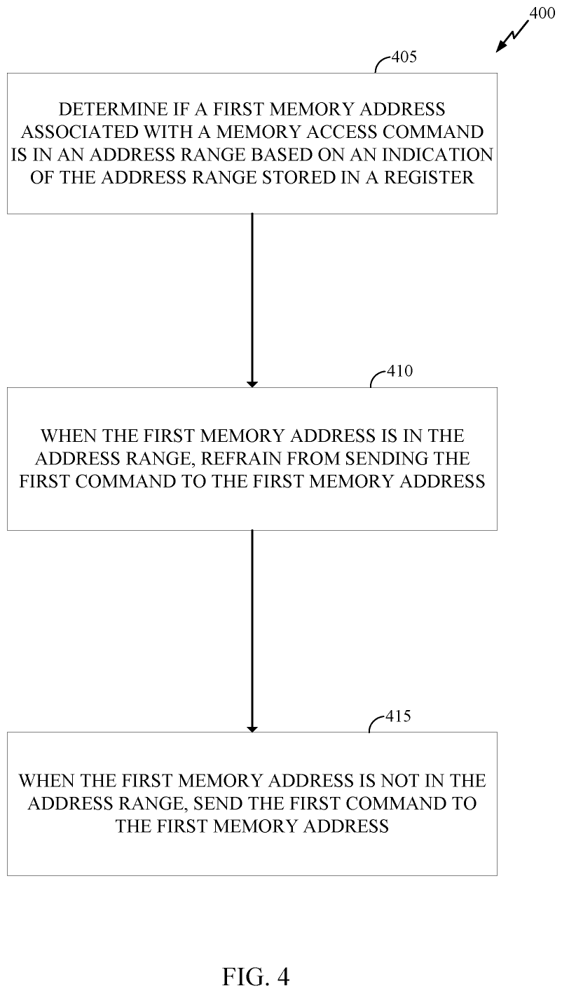

FIG. 4 illustrates exemplary operations for preventing access to executable code, in accordance with certain aspects of the present disclosure. Operations 400 begin at 405, where a circuit determines if a first memory address associated with a memory access command is in an address range based on an indication of the address range stored in a register. In certain aspects, the circuit may be a bus fabric coupled between a first CPU and a first memory. In some aspects, the circuit may be a firewall coupled between a first CPU and a first memory, wherein the register is in the firewall. In some aspects, the first CPU may be the CPU that loaded and executed the executable code. In some aspects, the executable code is the Power Management code of the SoC. At 410, if the first memory address of a first memory is in the address range removed from the memory map based on the indication of the address range stored in the register, the bus refrains from sending the first command to the first memory address. At 415, if the first memory address of the first memory is not in the address range removed from the memory map based on the indication of the address range stored in the register, the bus sends the first command to the first memory address.

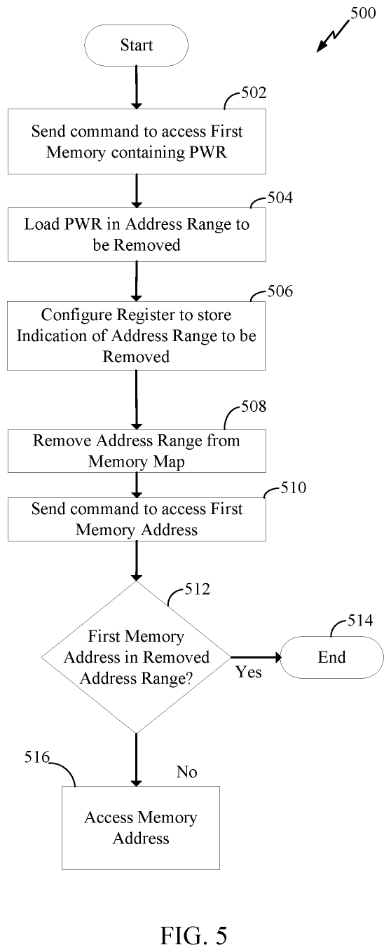

FIG. 5 is a flowchart of a method for preventing access to executable code in accordance with specific aspects of the present disclosure. Method 500 may begin at 502, where a CPUSS accesses a first memory where an executable code is stored. Examples of such codes may include PWR of SoC 100. At 504, CPUSS 105 loads the code in a memory address range to be removed from the memory map. In some aspects, the address range is defined in hardware accessible by the circuit. At 506, the register 187 in the bus fabric 185 stores an indication of the address range to be removed from the memory map. At 508, the bus fabric 185 removes the address range from the memory map based on the indication of the address range to be removed stored in the register 187. At 510, a CPUSS sends a first command associated with a first memory address to the bus fabric 185. In some aspects, the CPUSS may be a different CPUSS from the CPUSS that loaded the code in the memory address range to be removed. At 512, the bus fabric 185 determines if the first memory address is in the address range removed from the memory map. At 514, if the first memory address is in the address range removed from the memory map, the bus fabric 185 refrains from sending the first command to the first memory address. At 516, if the first memory address is not in the address range removed from the memory map, the bus fabric 185 sends the first command to the first memory address.

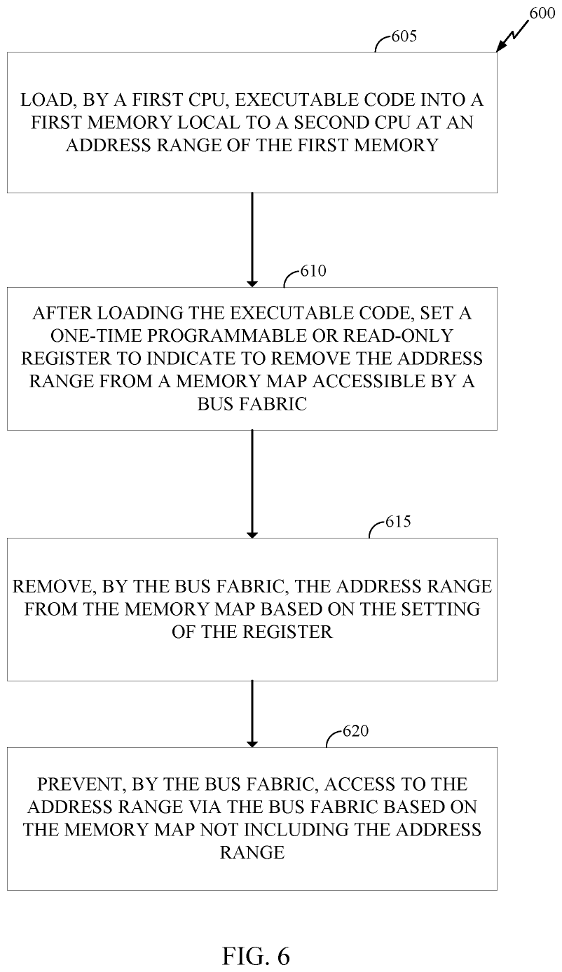

FIG. 6 illustrates exemplary operations of a method of preventing access to executable code according to certain aspects of the present disclosure. Method 600 begins at 605, where a first CPU loads executable code into a first memory local to a second CPU at an address range of the first memory. In certain aspects, the executable code may be PWR of SoC 100. At 610, a one-time programmable or read-only register is set to indicate to remove the address range from a memory map accessible by a bus fabric. In certain aspects, after the register is set, the register is set to not indicate to remove the address range from the memory map upon hard-reset. At 615, the bus fabric removes the address range from the memory map based on the setting of the register. At 620, the bus fabric prevents access to the address range via the bus fabric based on the memory map not including the address range. In certain aspects, the second CPU accesses the first memory independently of the bus fabric.

In some configurations, the term(s) ‘communicate,’ ‘communicating,’ and/or ‘communication’ may refer to ‘receive,’ ‘receiving,’ ‘reception,’ and/or other related or suitable aspects without necessarily deviating from the scope of the present disclosure. In some configurations, the term(s) ‘communicate,’ ‘communicating,’ ‘communication,’ ‘ may refer to transmit,’ transmitting,‘transmission,’ and/or other related or suitable aspects without necessarily deviating from the scope of the present disclosure.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits.

One or more of the components, steps, features and/or functions illustrated herein may be rearranged and/or combined into a single component, step, feature or function or embodied in several components, steps, or functions. Additional elements, components, steps, and/or functions may also be added without departing from novel features disclosed herein. The apparatus, devices, and/or components illustrated herein may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

These apparatus and methods described in the detailed description and illustrated in the accompanying drawings by various blocks, modules, components, circuits, steps, processes, algorithms, etc. (collectively referred to as “elements”). These elements may be implemented using hardware, software, or combinations thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, firmware, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, or combinations thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, PCM (phase change memory), flash memory, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

What is claimed is:

1. A computing system, comprising:
a first CPU configured to load an executable code for the computing system;
a first memory configured to store the executable code at an address range of the first memory, wherein the first memory is local to a second CPU;
a one-time programmable or read-only register configured to store an indication of the address range; and
a circuit configured to:
determine if a first memory address associated with a first memory access command is in the address range based on the indication of the address range stored in the register;
when the first memory address is in the address range, refrain from sending the first command to the first memory address; and
when the first memory address is not in the address range, send the first command to the first memory address.

2. The computing system of claim 1, wherein:
the circuit has access to a memory map of the computing system;
the address range is defined in hardware accessible by the circuit;
the circuit is configured to remove the address range from the memory map based on the register storing the indication of the address range;
the circuit being configured to determine if the first memory address associated with the first memory access command is in the address range comprises the circuit being configured to determine if the first memory address is in the memory map;
when the first memory address is in the address range comprises when the first memory address is not in the memory map; and
when the first memory address is not in the address range comprises when the first memory address is in the memory map.

3. The computing system of claim 2, wherein:
the indication is a single bit;
when the single bit is set, the circuit is configured to remove the address range from the memory map; and
when the single bit is not set, the circuit is not configured to remove the address range from the memory map.

4. The computing system of claim 3, wherein the single bit is set after the first CPU loads the executable code into the first memory, and wherein the first CPU cannot access the executable code after the single bit is set.

5. The computing system of claim 4, wherein the first CPU authenticates the executable code after it is loaded into the first memory, wherein the single bit is set after the first CPU authenticates the executable code.

6. The computing system of claim 2, wherein the second CPU can access the executable code after the address range is removed from the memory map.

7. The computing system of claim 6, wherein the first CPU is configured to access the first memory via the circuit, and wherein the second CPU is configured to access the first memory independent of the circuit.

8. The computing system of claim 1, wherein the executable code comprises a power management code of the computing system.

9. The computing system of claim 1, wherein the circuit comprises a firewall coupled between the first CPU and the first memory, wherein the register is in the firewall.

10. The computing system of claim 1, wherein the circuit comprises a bus fabric coupled between the first CPU and the first memory, wherein the register is in the bus fabric.

11. The computing system of claim 1, wherein the computing system comprises a system-on-chip.

12. A computing system, comprising:
a first CPU;
a second CPU;
a first memory configured to store an executable code at an address range of the first memory, wherein the first memory is local to a second CPU;
a bus fabric coupled between the first CPU and the first memory, and between the first CPU and the second CPU;
a one-time programmable or read-only register configured to store an indication of whether to remove the address range from a memory map of the computing system; and
wherein the bus fabric is configured to:
remove the address range from the memory map when the indication indicates to remove the address range from the memory map;
receive a first memory access command indicating a first memory address after removing the address range from the memory map;
when the first memory address is not in the memory map, refrain from sending the first command to the first memory address; and
when the first memory address is in the memory map, send the first command to the first memory address.

13. The computing system of claim 12, wherein the indication is a single bit, and wherein a definition of the address range is accessible by the bus fabric.

14. The computing system of claim 12, wherein the first CPU is configured to set the indication to indicate to remove the address range from the memory map after loading the executable code in the first memory and authenticating the executable code.

15. The computing system of claim 12, wherein the second CPU is configured to access the first memory independent of the bus fabric.

16. The computing system of claim 12, wherein the executable code comprises a power management code of the computing system.

17. The computing system of claim 12, wherein the computing system comprises a system-on-chip.

18. A method of preventing access to executable code, the method comprising:
loading, by a first CPU, executable code into a first memory local to a second CPU at an address range of the first memory;
after loading the executable code, setting a one-time programmable or read-only register to indicate to remove the address range from a memory map accessible by a bus fabric;
removing, by the bus fabric, the address range from the memory map based on the setting of the register;
preventing, by the bus fabric, access to the address range via the bus fabric based on the memory map not including the address range.

19. The method of claim 18, further comprising setting the register to not indicate to remove the address range from the memory map upon hard-reset.

20. The method of claim 18, further comprising accessing the first memory by the second CPU independently of the bus fabric.
